(19) United States
(12) Patent Application Publication
(10) Pub. No.: US 2004/0038610 A1
(43) Pub. Date: Feb. 26, 2004

(54) Press pads

(76) Inventor: Melvin Douglas, Rochdale (GB)

Correspondence Address: HARRISON & EGBERT, 412 MAIN STREET, 7TH FLOOR, HOUSTON, TX, 77002, US

(21) Appl. No.: 10/239,730

(22) PCT Filed: Apr. 3, 2001
(86) PCT No.: PCT/GB01/01534

(30) Foreign Application Priority Data
Apr. 8, 2000 (GB) 0008613.2

(51) Int. Cl. B32B 5/02

(52) U.S. Cl. 442/164; 428/105; 428/221; 442/60

(57) ABSTRACT

A press pad is provided for use in a laminate press operating at temperatures of up to 180° C. such as a high pressure laminate press or a veneer or marquetry press. The pad includes a woven fabric of strands that are heat resistant up to 200° C. and wherein a substantial proportion of at least one of the warp and the weft includes silicone covered strands. The fabric contains no metal strands and the other of the silicone covered strands includes at least one of a polyester and a non-aromatic polyamide yarn, such as nylon. Preferably, the silicone covered strands include a silicone covered glass yarn. The weight of such a pad can be made less than one third the weight of a conventional press pad containing a substantial proportion of metal wires, which facilitates the handling and manipulation of large press pads by press operatives. In addition, it is inexpensive to produce.

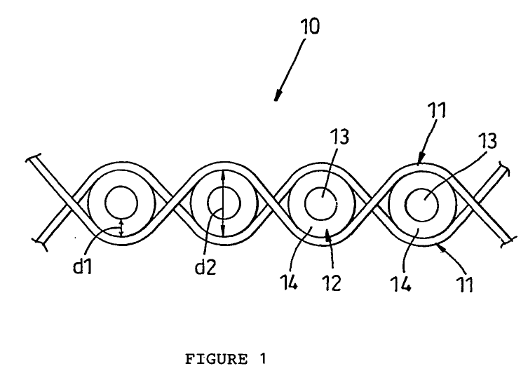

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a press pad for use in a laminate press.

### BACKGROUND OF THE INVENTION

The purpose of a press pad is to compensate for density variations in the laminate sheet and thereby ensure that an equal pressure is applied to all parts of the sheet by the press. In addition, a press pad is designed to compensate for any unevenness in the surfaces of the platens of the press itself and any flexure or bowing of the platens when under pressure. Again, this assists in the production of a flat even density laminate. Thus, it is important for a press pad to be resilient and have a natural springiness to permit it to compensate for the aforementioned density variations and the surface unevenness of the press platens but also to allow it to relax after each pressing operation and recover its form to enable it to be used again. The capacity a press pad has to re-form itself after each pressing is an important characteristic to ensure a reasonable working life.

Press pads are required in both high pressure and low pressure laminate presses. However, the press pad of the present invention has been particularly designed for use in a high pressure single or multi daylight laminate press for the production of high pressure laminate sheets and would be unsuitable for the satisfactory operation of a low pressure laminate press operating at temperatures above 180° C. High pressure presses typically have operating pressures in a range between 85 kg/cm² and 100 kg/cm² inclusive at temperatures of between 120° C. and 160° C. The pressing time is between 20 and 120 minutes. This contrasts with low pressure laminate presses where the operating pressure is between 25 kg/cm² and 35 kg/cm² inclusive at temperatures up to 220° C. for a pressing time of a few seconds, typically around 20 seconds.

In a low pressure laminate press, it is important for the press pad to conduct heat to the laminate sheet being pressed quickly in order that the press cycle time can be kept as low as possible and the press used efficiently. Consequently, low pressure press pads are designed with this requirement in mind. However, in a high pressure laminate press, as the pressing time is considerably longer than that of a low pressure press, the heat transfer capability of the press pad use is not an important factor in its design.

One feature that is important in the design of a high pressure press pad is its weight. High pressure laminate presses tend to comprise multi daylight presses wherein within each daylight of the press an interleaved stack of between 15 to 20 laminates and associated press plates and pads, which typically have dimensions of around 1350 mm by 3500 mm, are laid up. Such a press may typically have up to 22 separate daylights so that in a single pressing operation 440 laminate sheets may be pressed. The layering up of the press is usually accomplished manually, typically by two operatives who prepare the stacks within each of the daylights. As the press pads are stacked by hand, the weight of the press pads used is a relevant factor with regard to the efficiency of the layering up operation during which time the press is not in use.

Traditionally, a press pad used in high pressure laminate presses comprises a wad of kraft paper which is cut to an appropriate size. However, such a wad has the disadvantage that it only lasts for a very few number of press cycles before it must be discarded. As the thickness of the wad may be considerable, this leads to a significant waste disposal problem.

More recently, press pads have been proposed which will have a longer life than kraft paper wads. Such press pads comprise a woven textile made, inter alia, from yarns of aromatic polyamide fibers and metal threads. However, the presence of metal threads in such a press pad has the disadvantage that it significantly increases the weight of the pad.

In EP 0735949 is described a woven press pad for use in both high pressure and low pressure laminate presses wherein a substantial proportion of either or both the warp or the weft comprises a silicone elastomer. However, it is also a requirement of the press pad described therein that it contains metal strands, which means that this press pad is also subject to the aforementioned disadvantage.

Apart from the aforementioned high and low pressure laminate presses, there are laminate presses for the production of veneers and marquetry which operate at very low pressures of around 5 kg/cm² at temperatures in the range 120° C.-130° C. for a pressing time of around 30 seconds. The heat transfer capability of the mat is again not a significant requirement in these presses and conventionally cork press pads are used. However, these cork pads have the disadvantage that they wear out quickly. In addition, cork is becoming more expensive.

It is an object of the present invention to provide a press pad for use in a laminate press wherein heat transfer is not a primary consideration, such as a high pressure laminate press or a veneer or marquetry press, which overcomes or substantially mitigates the aforementioned disadvantages.

### BRIEF SUMMARY OF THE INVENTION

According to the present invention, there is provided a press pad for use in a laminate press operating at temperatures of up to 180° C. comprising a woven fabric of strands that are heat resistant up to 200° C. and wherein a substantial proportion of at least one of the warp and the weft comprises silicone covered strands, and characterized in that the fabric contains no metal strands, and in that the other of the warp and the weft comprising the silicone covered strands comprises at least one of a polyester and a non-aromatic polyamide yarn such as nylon.

Polyester and non-aromatic polyamide yarns are capable of withstanding temperatures of up to 200° C. such as are encountered in high pressure laminate presses, and veneer and marquetry presses but would not be capable of the temperatures encountered in low pressure laminate presses where typically the average temperature is around 220° C. However, the advantage of polyester and non-aromatic polyamide yarns for the purpose in question is that they are inexpensive unlike the much more expensive aromatic polyamide yarns, such as are sold under the trademarks KEVLAR (TM) and NOMEX (TM), which are capable of withstanding considerably higher temperatures. The press pad of the present invention therefore has the advantage of being economical to produce and, as it contains no metal strands, of being relatively lightweight.

Preferably also, the silicone covered strands comprise silicone covered glass yarn. Advantageously the glass yarn comprises continuous filament glass yarn that has a diameter of around 0.38 mm.

Advantageously, the glass yarn is covered with an extruded coating of silicone to a depth of around 0.2 mm.

Preferably also, the woven fabric has a warp comprising polyester yarns or non-aromatic polyamide yarns and a weft comprising silicone covered glass yarns.

One disadvantage of polyester yarn is that it shrinks when initially subjected to the temperatures that are encountered in high pressure laminate presses. If no steps are made to take this into account, a press pad comprising a polyester warp will shrink by up to 8% in the warp direction after it has been used for the first time. Preferably, therefore, the press pad of the present invention comprises a pre-shrunk woven fabric which has been subjected to a temperature of 190° C. for a predetermined period. Such a fabric, when subjected to the temperatures encountered in a high pressure laminate press, will not shrink significantly further during use.

### BRIEF DESCRIPTION OF THE SEVERAL VIEWS OF THE DRAWINGS

An example of a press pad according to the present invention will now be described by way of example with reference to the accompanying drawing which comprises a diagrammatic cross-sectional view, scale, of such a press pad.

### DETAILED DESCRIPTION OF THE INVENTION

As shown in the drawing, a press pad 10 according to the invention for use in a high pressure laminate press comprises a single ply woven fabric which is made of materials that are heat resistant to 200° C. The press pad 10 comprises warp threads 11 and the weft threads 12, neither of which includes metal strands or yarns.

In order to maximize the resilience and springiness of the pad, the weft threads 12 comprise silicone covered threads. In the present example glass yarns 13 are provided with an extruded silicone elastomeric outer covering 14. Preferably, the specific gravity of the silicone elastomeric covering 14 falls within the range of 1.1 g/cm³ to 1.4 g/cm³ inclusive in order to secure the best properties wherein it is neither sufficiently springy under compression nor too brittle. The wall thickness d1 of the covering 14 is preferably at least 0.2 mm and the overall outside diameter d2 of the silicone covered yarn is of the order of 0.78 mm, the outside diameter of the glass yarn being in the region of 0.38 mm. In such an arrangement the silicone comprises 59% of the yarn by weight.

Suitable glass yarn for covering with silicone in this way is 3 ply, 68 tex continuous filament glass yarn. However, any suitable non-metal strands could be used as a carrier for the silicone elastomer. The advantages of glass yarn are that it is flexible so that it can be woven easily, that it can withstand the curing temperatures of around 600° C. encountered in silicone extruder curing devices after leaving a silicone extruder so that it can be readily coated, and that it is relatively inexpensive. However, other carriers for the silicone, such as aromatic polyamide yarns, could be used provided that they can be adequately covered with silicone.

The warp threads 11 of the press pad are preferably made from either polyester or a non-aromatic polyamide such as nylon. A 5 ply, 74 tex polyester yarn has been found to be suitable for the purpose. Such yarns, whilst incapable of withstanding temperatures in excess of 200° C. as would be encountered in a low pressure laminate press are capable of withstanding the temperatures of up to 180° C. used in high pressure laminate presses. However, they do have the disadvantage that they shrink when initially subjected to such temperatures. Preferably, therefore, after weaving the woven fabric to be used for making the press pads is pre-shrunk by being heated to a temperature of 190° C. for approximately ten minutes. Thereafter, the fabric can be cut into appropriately sized mats for use as press pads and it will not shrink significantly further in the warp direction during use.

The fineness of the weft and the warp yarns, as indicated above, results in a press pad with a relatively smooth surface, which is advantageous in some applications and mirrors the smooth surface of the kraft paper wads it is intended to replace.

The press pad shown in the drawing is woven in a plain weave with 118 warp threads per decimeter and 71 weft thread per decimeter. The weight of such a pad comprising polyester warp and a silicone-covered glass yarn weft is 965 g/m². This is less than one third the weight of a conventional press pad wherein metal wires are used for the warp and silicone covered metal wires are used for the weft. In addition, the total absence of metal from the press pad of the present invention means that the edges of the pad can be overlooked and neatly finished with no protruding metal wires. These advantages greatly facilitate the handling and manipulation of large press pads by press operatives.

I claim:

1. A press pad for use in a laminate press operating at temperatures of up to 180° C. comprising a woven fabric (10) of strands that are heat resistant up to 200° C. and wherein a substantial proportion of at least one of the warp (11) and the weft (12) comprises silicone covered strands (12), characterized in that the fabric (10) contains no metal strands, and in that the other of the warp (11) and the weft (12) comprising the silicone covered strands (12) comprises at least one of a polyester and a non-aromatic polyamide yarn such as nylon.

2. A press pad as claimed in claim 1, characterized in that the silicone covered stands (12) comprise silicone covered glass yarn (13, 14).

3. A press pad as claimed in claim 2, characterized in that the glass yarn (13) comprises continuous filament glass yarn that has a diameter of around 0.38 mm.

4. A press pad as claimed in any one of claims 1 to 3, characterized in that the silicone covered strands (12) are covered with an extruded coating of silicone (14) to a depth of around 0.2 mm.

5. A press pad as claimed in any one of claims 1 to 4, characterized in that the woven fabric (10) has a warp (11) comprising polyester yarns and a weft silicone covered glass yarns.

6. A press pad as claimed in any one of claims 1 to 4, characterized in that the woven fabric (10) has a warp (11) comprising non-aromatic polyamide yarns and a weft (13) comprising silicone covered glass yarns.

7. A press pad as claimed in any one of claims 1 to 6, characterized in that it comprises a pre-shrunk woven fabric (10) which has been subjected to temperature of 190° C. for a predetermined period.
